(19) United States
(12) Patent Application Publication
(10) Pub. No.: US 2020/0408556 A1
(43) Pub. Date: Dec. 31, 2020

(54) METHOD AND SYSTEM FOR RENDERING A NAVIGATIONAL DIRECTION TO A USER

(71) Applicant: KAHA PTE. LTD., Singapore (SG)

(72) Inventor: Sudheendra SHANTHARAM, Bengaluru (IN)

(73) Assignee: KAHA PTE. LTD., Singapore (SG)

(21) Appl. No.: 16/977,789

(22) PCT Filed: Mar. 1, 2019
(86) PCT No.: PCT/SG2019/050120

§ 371 Date: Sep. 2, 2020

(30) Foreign Application Priority Data
Mar. 3, 2018 (SG) 10201801750Y

(51) Int. Cl. G01C 21/36; G04G 9/00; G04B 47/06

(52) U.S. Cl. CPC G01C 21/3632; G04B 47/06; G04G 9/007; G01C 21/3661

(57) ABSTRACT

In an embodiment, the method for rendering the navigational direction to the user, the method comprising the steps of: determining location based information of a destination station; computing a current location of the user and a navigational direction toward the destination station from the current location of the user; selecting at least one mode of operation of a watch, wherein the at least one mode of operation includes rendering a navigational direction to the destination station on a watch dial; rendering a plurality of indicators within at least an inner area of the watch dial and an outer periphery of the watch dial; and rendering a pointer on the watch dial indicating the navigational direction to the user.

### TECHNICAL FIELD

The disclosure related to the field of a navigation method and more particularly to the method and system for rendering a navigational direction to a user on a watch dial.

### BACKGROUND

Navigation is one of the primary requirements of a user while performing day to day personal or business activities. For long and uncharted journeys, the user typically carries a compass to locate a reference direction on a map so that the user can use the compass and the map to reach to a desired location. However, with an advent of technology, the user gains access to a mobile application which is configured in such a manner to provide details of one or more navigation routes between a source station (location) and a destination station (location). The user travels through a selected route from the one or more navigation routes to reach the destination station. However, the existing methods require the user to carry additional devices which can cause inconvenience to the user while travelling. For example, the user requires access to the mobile device at intermittent intervals while driving toward the destination station. Various reports disclose that there exists a substantial increase in road accidents while the user travelling and accessing the mobile device to locate the destination route at an approximate same time.

Furthermore, the one or more navigation routes are determined depending on a minimum time or distance required to travel between the two stations. At times, the user selects a specific navigation route as per his requirements and traverses through the specific navigation route to reach the destination station. However, it is likely possible that the specific navigation route may not be a best route for the user due to security issues associated with at least a portion of the specific navigation route. As a result, the user may encounter situations which pose a considerable level of security concerns for the user. In view of foregoing discussion, there exists a need for a method and a system for rendering navigation route to the user which can increase convenience as well as security for the user.

### BRIEF DESCRIPTION OF THE FIGURES

In the accompanying figures, like reference numerals refer to identical or functionally similar elements throughout the separate views and together with the detailed description below are incorporated in and form part of the specification, serve to further illustrate various embodiments and to explain various principles and advantages all in accordance with the systems and methods disclosed herein.

FIGS. 1A and 1B illustrate exemplary architectures of a system for rendering a navigational direction to a user in accordance with an embodiment of the disclosure;

FIGS. 2A and 2B illustrate exemplary functional block diagrams of a watch and a smart watch respectively in accordance with an embodiment of the disclosure;

FIGS. 3A and 3B illustrate exemplary architectures of a system for establishing communication between a plurality of watches and the mobile device in accordance with an embodiment of the disclosure;

FIGS. 4A, 4B and 4C illustrate exemplary representations of a watch dial displaying the direction to be travelled by the user in accordance with an embodiment of the disclosure.

FIG. 5 illustrates an exemplary watch dial configured to indicate a navigational direction to a user in accordance with an embodiment of the disclosure;

FIGS. 6A, 6B, 6C and 6D illustrates exemplary watch dials wherein hands of the watch and the outer periphery are actuated simultaneously to indicate the navigational direction to the user in accordance with embodiment of the disclosure;

FIGS. 7A and 7B illustrate exemplary representations of the watch dial for rendering multiple route selection option to the user in accordance with an embodiment of the disclosure; and

FIG. 8 illustrates an exemplary representation of the watch dial to indicate a lane to the user in accordance with an embodiment of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the systems and methods disclosed herein.

### DETAILED DESCRIPTION

Provided herein are a method and a system for rendering a navigational direction to a user on a watch dial.

In an embodiment, the method for rendering the navigational direction to the user, the method comprising the steps of: determining location based information of a destination station; computing a current location of the user and a navigational direction toward the destination station from the current location of the user; selecting at least one mode of operation of a watch, wherein the at least one mode of operation includes rendering a navigational direction to the destination station on a watch dial; rendering a plurality of indicators within at least an inner area of the watch dial and an outer periphery of the watch dial; and rendering a pointer on the watch dial indicating the navigational direction to the user.

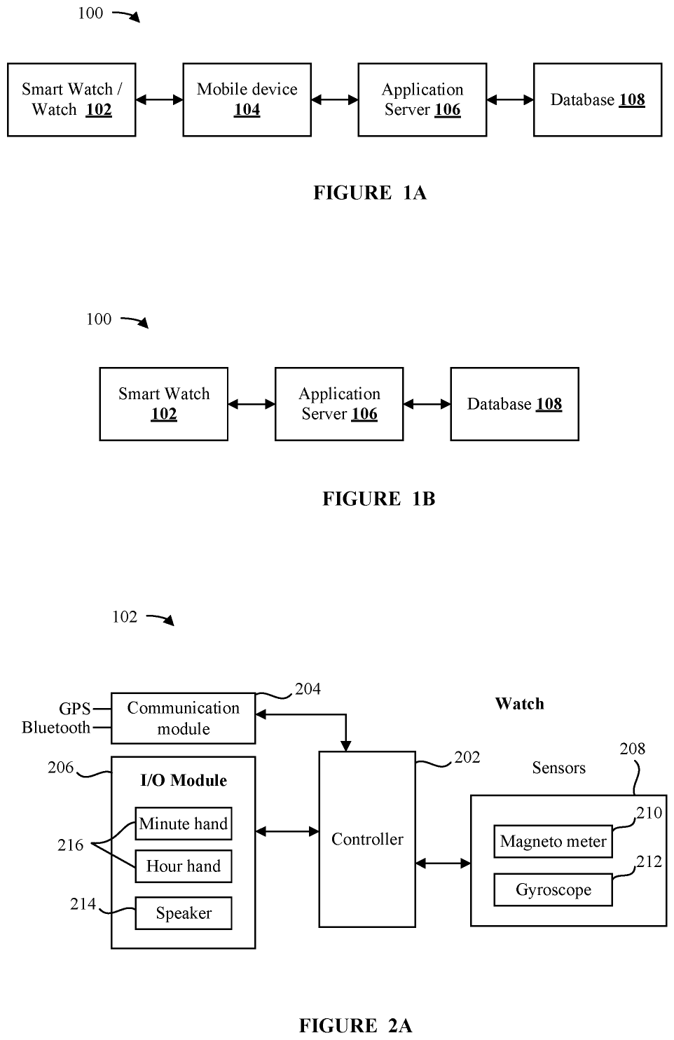

FIGS. 1A and FIG. 1B illustrate exemplary architectures of a system for rendering a navigational direction to a user in accordance with an embodiment of the disclosure. As illustrated in FIG. 1A, the system 100 includes a watch 102 communicatively coupled to a mobile device 104 which in turn is communicatively coupled to an application server 106. The application server 106 is configured to record one or more forms of navigational data and user's profile data in a database 108. In an embodiment, the user can access both the watch 102 as well to the mobile device 104 and gains further access to the navigational direction to reach a destination station. In an embodiment, the watch 102 can include and is not limited to an analog watch, a smart watch or any type of multi-utility watch. The watch 102 is configured to be connected/paired to the mobile device 104 of the user. The mobile device 104 is configured with an application to monitor, analyze, record and store the operations of the watch 102. The mobile device 104 is further configured with a built-in GPS system. The GPS can determine the current position of the user as the mobile device 104 is within the accessible range of the user. The mobile device 104 (mobile application) is communicatively connected to the application server 106 to transfer data as received from the watch 102 and the mobile device 104. Subsequently, the application server 106 is configured to process the data and perform one or more set of operations to determine the navigational direction for the user and transmit the navigational direction to the watch 102 through the mobile device 104.

In another embodiment such as illustrated in FIG. 1B, the watch 102 is configured to include a built-in GPS and is directly connected to the application server 106. The watch 102 is configured to receive the navigational direction from the application server 106.

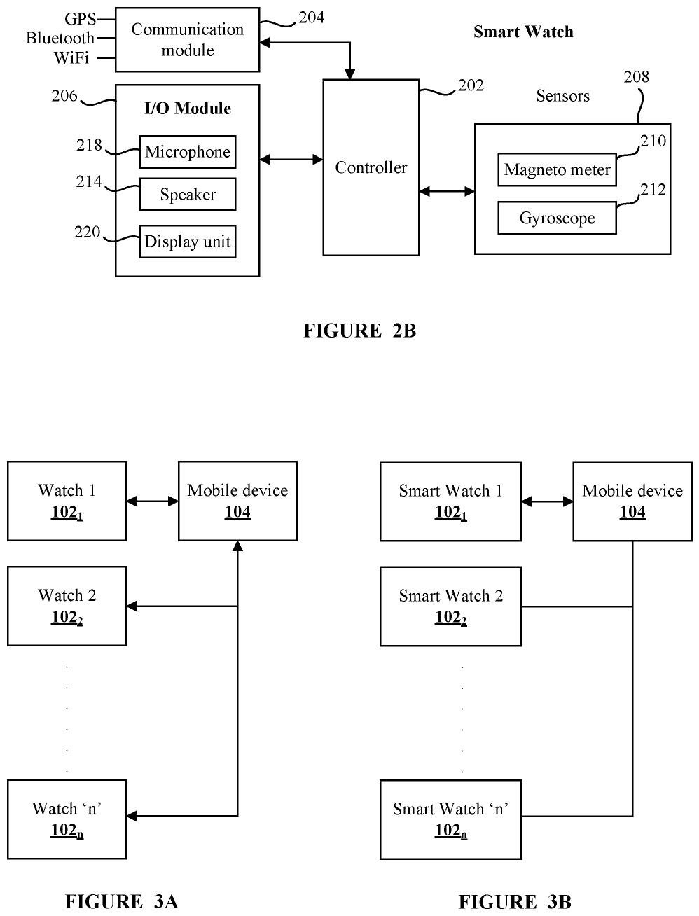

FIGS. 2A and 2B illustrate exemplary functional block diagrams of a watch and a smart watch in accordance with an embodiment of the disclosure. The watch 102 of FIG. 2A includes a controller 202, a communication module 204, an I/O module 206 and a sensor module 208. In an embodiment, the sensor module 208 includes a magnetometer 210 and a gyroscope 212. The magnetometer 210 is used to determine direction of a position/location. The gyroscope 212 is configured to determine the orientation of the watch 102. In an embodiment, the hand (with watch) of the user is kept parallel to the ground to determine the exact position of the watch 102. The watch 102 may also include a speaker 214 to notify (inform or alert) the user of the directions/location.

In an embodiment, the communication module 204 is configured to transmit the real-time location data (from watch 102) to the application server 106 and receive (map related information) from the application server 106. In an embodiment, the communication module 204 receives the map information from the mobile device 104. The map related information (geographical co-ordinates) is transmitted in the form of latitude and longitude. In an embodiment, a method of determining the position of arms of watch 102 is disclosed. The method comprises the steps of: receiving map related information from the mobile device 104 or from the application server 106, converting the map related information into one or more parameters; selecting one or more arms 216, determining the angle variations of an arm 216 (variations of minute, hour and second hand with respect to its current positions) of the watch 102 based on the one or more parameters, positioning the arms 216 for the determined angle variation and moving the arms 216 to a location (on a watch dial) displaying the actual direction required for the movement of the user.

In an embodiment, the mobile application is configured to receive the map related input from the user (for example, destination location and the like). The source location of the user is automatically determined by the global positioning system (GPS) of the mobile device 104. In an embodiment, the communication module 204 of watch 102 receives map related information from the mobile device 104. The map related information can include and is not limited to a source location, a destination location, terrain information, path related information, directional information (from source to destination) and among other location-based information. The magnetometer 210 and gyroscope 212 of the watch 102 are configured to share the real-time positional and directional information of the watch 102 to the controller 202.

In an embodiment, the controller 202 is configured to compare the received map related information with the positional and directional information (received from magnetometer 210 and gyroscope 212) of the watch 102 to determine an actual directional route information to the destination location (as selected by the user) from the source location of the user. In another embodiment, the magnetometer 210 reads the current position of the watch 102 (only when the watch 102 is kept parallel to the ground, or the hand of the user is kept parallel to the ground, if he is wearing that watch 102) and compares with that of the received information (from the mobile device 104 i.e., the destination location). Subsequently, the controller 202 is configured to operate an associated micromotor of the arm 216 so that a navigational direction can be indicated to the user on the dial of the watch 102. For example, the micromotor actuates the minute or hour or second hand to show the direction of destination location. In an embodiment, the magnetometer 210 is configured to detect all eight directions including at least north, south, east, west, north east, north west, south east, south west. In an embodiment, all hands 216 of watch 102 are actuated simultaneously converging to a direction of the destination location. In another embodiment, individual hands 216 of watch 102 are actuated displaying the direction of location of destination.

In one example, the dial numbers (3, 6, 9, 12) indicate the directions (east, south, west, north) respectively. In a yet another embodiment, the gyroscope 212 is configured to determine orientation of the watch 102 and appropriately send a real-time gyro value to the controller 202. In other words, the numbers indicated in the watch dial can be capable of displaying all directions and all necessary turns (to make) in a real-time by the user to reach the destination location. In another example, the magnetometer 210 and gyroscope 212 of watch 102 shall instruct the user to take appropriate orientation and indicate the direction of travel to the user through the needles (arms/hands) 216 of the watch 102.

FIG. 2B illustrates an exemplary block diagram of one or more modules of the smartwatch in accordance with an embodiment of the disclosure. In an embodiment, the smart watch 102 is configured to include additional components such as microphone 218, speaker 214 and a display unit 220. The smart watch 102 can operate and find the position of the user and appropriately detect the direction to be travelled from the inputs (details about destination location) given by the user. The smart watch 102 can even display a map or any geographical indication. A communication module 204 of the smart watch 102 may have a wireless and Bluetooth module. The map may further include the features of showing terrain information, traffic information, satellite imagery etc. The user can perform any activity but not limited to walking, driving etc. The smart watch 102 may receive the inputs from the user either through display unit (touch display) 220 or over microphone 218. The smart watch 102 is also capable of receiving such directional inputs from user and appropriately change the direction of travel. The speaker 214 of smart watch 102 is used to notify (inform or alert) the user to take appropriate turn during the travel to the destination location. In an embodiment, the smart watch 102 may also be paired with the mobile device 104 and can receive the directional updates from the mobile application. In a yet another embodiment, the smart watch 102 shall display distance to be travelled to reach the destination. Further, the unit of distance may be measured and displayed in number of steps, kilometers or in any metric system.

FIG. 3A illustrates an exemplary architecture of a system for establishing communication between a plurality of watches (102₁, 102₂, . . . 102n) with the mobile device 104 in accordance with an embodiment of the disclosure. In other words, multiple watches (102₁, 102₂, . . . 102n) can be connected to a single mobile application (mobile device) in real-time and share the directional and map related information. In an embodiment, the mobile application can create profiles for every user. FIG. 3B illustrates an exemplary architecture of a system for establishing communication between a plurality of smart watches (102₁, 102₂, . . . 102n) and the mobile device 104 in accordance with an embodiment of the disclosure.

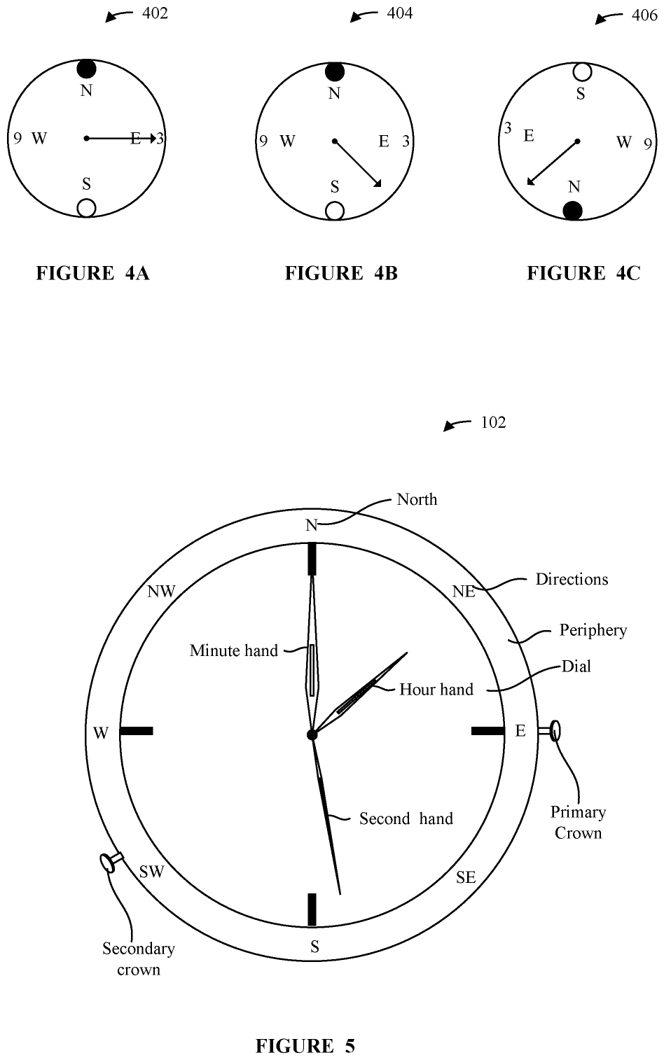

FIGS. 4A, 4B and 4C illustrate exemplary representations 402, 404 and 406 respectively of a watch dial displaying the direction to be travelled by the user in accordance with an embodiment of the disclosure. FIG. 5 illustrates an exemplary dial of a watch dial configured to indicate a navigational direction to a user in accordance with an embodiment of the disclosure. The watch dial includes a primary crown and a secondary crown. The primary crown is used to control the hands of the watch 102 when the watch 102 is used for rendering current time to the user. The secondary crown is used to select one or more modes of operation of the watch dial. The one or more modes of operation of the watch dial includes and is not limited to selection of the navigational direction with respect to true north, multi route option, lane determination, track movement, indoor navigation and the other navigational directions for the user. Further various directions are shown on an outer periphery of the watch dial to assist the user. In an embodiment, various directions are embossed on a rotatable outer periphery of the watch dial. In another embodiment, the outer periphery includes a circular display panel configured to display the various directions. In an embodiment, the watch 102 may switch to directional mode when the secondary crown is operated (example, rotated or pressed) in a particular manner. For example, a single long press (2-3 seconds) or one full rotation of secondary crown may switch the watch 102 from time display mode to directional mode. In another embodiment, one or more arms of watch 102 are moved in such a way, to show North direction, by default. Upon entering the directional mode, the secondary crown may be used to select various other travel modes/selections.

In another embodiment, the one or more micro motors of the watch 102 is capable actuating and moving the arms of the watch 102, through a pre-set angle values and other related values. A memory unit (not shown) in a watch 102 is capable of storing all machine related parameters along with the parameters from magneto meters, gyroscope and application server. The memory unit stores plurality of parameters and its pre-set values, real-time values (to operate the watch 102 both in time display mode and directional mode) relating to any activity and operation on the watch 102. The parameter includes, but not limited to, micromotor data (rotation of micromotor, speed of rotation, number of micro motor actually operated in directional mode and time display mode or to be operated), watch dial data (its rotation, information relating to directional pointer), geographical data (co-ordinates, path), sensor data, Navigational data (safe path, longest, shortest) etc. The memory unit shares the data relating to each parameter with the micro controller, while processing. The micro controller is capable of analyzing, the parameters and determining at least one travel route for the user.

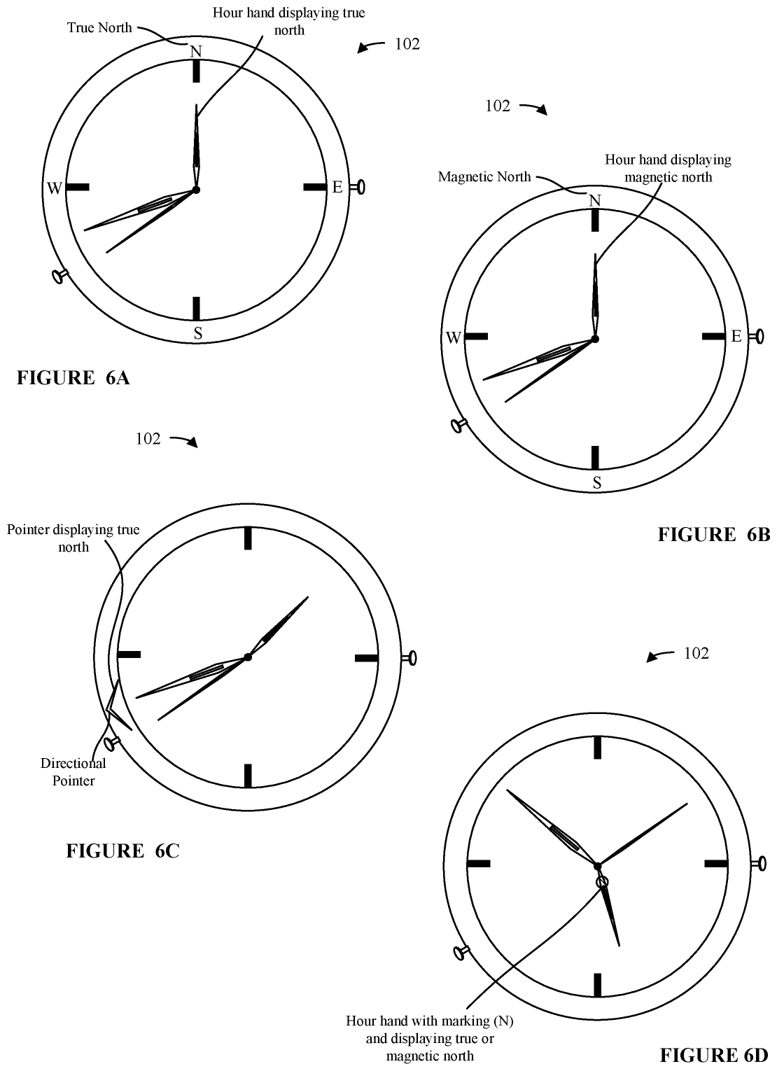

FIGS. 6A, 6B, 6C and 6D illustrates exemplary watch dials wherein hands of the watch 102 and the outer periphery are actuated simultaneously to indicate navigational direction to the user in accordance with embodiment of the disclosure.

As shown in FIG. 6A, the hour hand of the watch dial indicates toward the true north direction whereas the hour hand in the FIG. 6B indicates toward the magnetic north direction. In FIGS. 6A and 6B, the outer periphery is marked with the directions. The other hands of the watch 102 indicate the navigational direction to the user.

In FIG. 6C, a directional pointer is shown on the outer periphery of the watch dial whereas in FIG. 6D, a marking in disposed on the hour hand in a manner to indicate north direction. In FIG. 6C, the outer periphery (having the directions) is also auto-rotated to match the pointer location (directional pointer). The north direction of FIG. 6C and FIG. 6D can be a true north direction or magnetic north direction depending on the selection of mode chosen by the user using the secondary crown of the watch dial.

In an embodiment, the hour hand is configured to point toward the North direction in all modes of operation. In case the user changes his direction, the hour hand is configured to change to the north direction accordingly. In another embodiment, either minute hand or the hour hand is used to show the true north direction or magnetic north direction respectively. In an embodiment, the hour hand or any one of the hand, is coupled to the magnetometer

In an embodiment, the hands of the watch 102 remain static and the outer periphery is rotated displaying the navigational direction for the user. Further, the directions (north, east, south, west or any other directions) on periphery are pointed (matches) either with the hour or minute hand. In another embodiment, the hour hand will be showing the true north and the outer periphery (the directions) is matched to the minute hand.

In a yet another embodiment, the minute or hour hand will display the true north always (no pointer on periphery or directional ways written on the periphery).

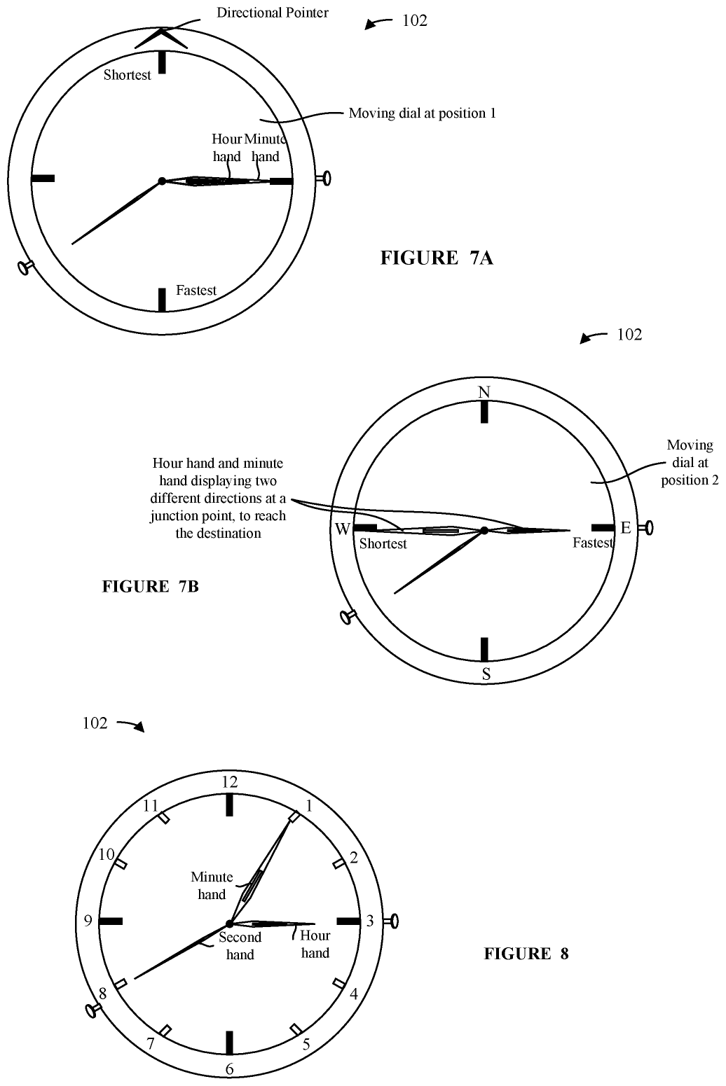

FIGS. 7A and 7B illustrate exemplary representations of the watch dial for rendering multiple route selection option to the user in accordance with an embodiment of the disclosure. In an embodiment, the user presses the secondary crown to select the route to reach the destination station. For example, a shortest route to the destination station is selected when the user presses the secondary crown once and a fastest route is selected when the user presses the secondary crown twice. In the route determination mode, the hands of the watch 102 are coincided displaying the direction of travel or movement of the user.

In FIG. 7A, the hands of watch 102 are displaying the actual direction of travel (both hour and minute hand are coincided). In one example, route selected by the user (first time), may have different turns and directions to reach the destination station. The movement is monitored in such a manner to suggest the user with the best possible routes, which may be fastest, shortest or safest or any other manual route selected by the user. In an embodiment, the application server is configured to evaluate above routes in real-time and accordingly notify the user (in the watch 102). In another embodiment, the evaluation of route is performed time to time, by the micro controller.

In an embodiment, when the user is in a junction, the watch 102 is configured to show different routes (fastest, shortest, safest and the like) to the user, by means of hands of the watch 102. For example, the user chooses a travel route and starts moving towards the destination station, and the subject travel route is evaluated whenever there is a turn, junction, or deviation (when the user is not moving in the suggested route) in the travel route. Further, the information relating to the evaluation of subject travel route is updated in the application server either through directly or through a mobile application connected with the smart watch 102. The hands of the watch 102 (correlated to fastest, shortest safest) are actuated to display the direction of at least one of travel route to the user. For example, the hour hand may show the fastest and minute hand shall show the shortest route or vice versa. The user can select any one of the route to reach the destination, by appropriately actuating the secondary crown. In an embodiment, a separate micro motor is configured to rotate the watch dial. The information relating to travel route is printed on the watch dial. For example, safest, shortest, fastest etc. When, the user is in a junction, a choice is given to the user to select the path of travel. The hands of the watch 102 are moved to display different travel routes (fastest, shortest, and safest).

FIG. 7B illustrates an example route menu displayed to the user in accordance with an embodiment of the disclosure. The hands, the dial and the periphery of the watch 102 are operated in tandem to display suitable directional features to the user. In another embodiment, the dial may have location parameters (fastest, shortest, safest and the like) written. In a yet another embodiment, after the selection of fastest route to reach destination, the user is also given other options (such as, to select safest route from his location or to select other route possibilities to reach the destination). Also, the user can select other route options anytime.

In a yet another embodiment, the dial is rotated to match the position of the hands displaying the directions. In an embodiment, the watch dial operates simultaneously and in correlation with the movement of hands. In other words, the micro motors if hands and watch dial are operated simultaneously and in synchronization with each other. Further, the hands of watch 102 (programmed for displaying different travel routes) exactly matches with the words printed on watch dial such as shown in FIGS. 7A and 7B. Further, the pointer in the outer periphery always displays true north to the user. In an embodiment, the pointer in the outer periphery (in FIG. 7A) shall display the true north or magnetic north, always.

FIG. 8 illustrates an exemplary representation of the watch dial to indicate lane to the user in accordance with an embodiment of the disclosure. The hands of the watch 102 are used to display different parameters to the user. In an embodiment, the hour hand indicates toward the true north always. In another embodiment, the hour and the minute hand are used to display the direction of travel and lane details, respectively and vice versa. Further, the magnetic north or true north may not be shown in this mode. The second hand is used only when, the hour hand is showing true north. In an embodiment, the minute hand is pointed to a position showing the lane to maintain (for example, 1 or 2) in a vehicle mode, and the hour hand shall show, the direction of travel (in this case, the user should take right turn in a travelling road). In an embodiment, the user can select travel modes. The travel modes include but not limited to walking, jogging, driving, custom mode or any other mode. In another embodiment, the user may customize the travel and the watch 102 automatically identifies the mode of travel (through the accelerometer).

As illustrated in FIG. 8, the user is in driving mode, and the watch 102 is displaying the direction of travel, and lane to maintain. The data is dynamically updated in the watch 102 displaying the direction of travel. Further, when a secondary crown is pushed once, then the hour hand is configured to immediately show the true north or magnetic north for a while (for example, 5 seconds) and return to its original position showing the direction of movement of user. In an embodiment, the dial, hands and periphery of the watch 102 are connected/coupled to various motors, which are operated simultaneously to perform one task. In another embodiment, the dial, hands and periphery of the watch 102 are interconnected performing various actions in real-time.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another. The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions.

It will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium. The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions. Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction. The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure. While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure. All documents referenced herein are hereby incorporated by reference.

We claim:

1. A method for rendering a navigational direction to a user on a watch, the method comprising the steps of:
receiving inputs from the user pertaining to location information of a destination station;
determining location information of a current station of the user;
determining information pertaining to a plurality of navigational paths initiating from the current station and ending at the destination station, wherein the information pertaining to the plurality of navigational paths comprises at least one type of map comprising the destination station and the current station of the user;
rendering a plurality of pointers representing the plurality of respective navigational paths within at least an inner area of a dial of the watch and an outer periphery of the dial of the watch, wherein the plurality of pointers includes a first set of pointers rendered within the inner area of the dial of the watch and a second set of pointers rendered on the outer periphery of the dial of the watch, wherein the first set of pointers are dependent on the location information of the destination station and the current station; the second set of pointers are dependent on the current station;
receiving an input of the user regarding selection of at least one indicator from at least the first set of pointers and the second set of pointers; and
rendering at least one type of map and the navigational path corresponding to the user selected indicator within an inner area of the dial of the watch.

2. The method as claimed in claim 1, further comprising:
presenting pointing directions of an hour hand, a minute hand and a second hand of the watch as representatives of a first indicator, a second indicator and a third indicator selected from the first set of pointers;
receiving an input from the user to select at least one of the first indicator, the second indicator and the third indicator; and
controlling movement of the hour hand, the minute hand and the second hand to map the pointing directions of the user selected indicator and the respective navigational path on the at least one type of map.

3. The method as claimed in claim 2, wherein:
the first indicator indicates a shortest path between the current station and the destination station; the second indicator indicates a fastest path between the current station and the destination station; and the third indicator indicates a safest path between the current station and the destination station.

4. The method as claimed in claim 3, further comprising:
determining angular movements for each of the hour hand, the minute hand and the second hand required to maintain a correlation between the respective pointing directions and corresponding navigational paths on the at least one type of map; and
controlling the rotational directions of each of the hour hand, the minute hand and the second hand in accordance with respective determined angular movements.

5. The method as claimed in claim 4, further comprising:
receiving real time information regarding the shortest path, the fastest path and the safest path between the current station and the destination station; and
controlling the rotational directions of each of the hour hand, the minute hand and the second hand in accordance with the real time information.

6. The method as claimed in claim 3, further comprising:
actuating at least one of a first crown to select a first mode of operation and a second crown to select a second mode of operation, wherein the first mode of operation renders time on the dial and the second mode of operation renders navigational path on the dial.

7. The method as claimed in claim 6, further comprising: actuating the second crown in a predefined manner to select at least one of the first indicator, the second indicator and the third indicator.

8. The method as claimed in claim 1, further comprising:
embossing the second set of pointers on the outer periphery of the dial;
actuating at least one motor to control rotation movement of the outer periphery of the dial in accordance with movement of the user while the user passes through the rendered navigational direction path.

9. The method as claimed in claim 1, further comprising: controlling movement of the second set of pointers on the outer periphery of the dial in accordance with movement of the user while the user passes through the rendered navigational direction path.

10. The method as claimed in claim 9, wherein the second set of pointers indicate to respective directions selected from a group of direction comprising north, south, east, west, north east, north west, south east, south west and magnetic north.

11. A system for rendering a navigational direction to a user on a watch, the system comprising the steps of:
a first user interface configured to receive inputs from the user pertaining to location information of a destination station;
a global positioning device configured to determine location information of a current station of the user;
a receiver configured to receive information pertaining to a plurality of navigational paths initiating from the current station and ending at the destination station, wherein the information pertaining to the plurality of navigational paths comprises at least one type of map comprising the destination station and the current station of the user;
a controller configured to render a plurality of pointers representing the plurality of respective navigational paths within at least an inner area of a dial of the watch and an outer periphery of the dial of the watch, wherein the plurality of pointers includes a first set of pointers are rendered within the inner area of the dial of the watch and a second set of pointers are rendered on the outer periphery of the dial of the watch, wherein the first set of pointers are dependent on the location information of the destination station and the current station; the second set of pointers are dependent on the current station;
a second user interface configured to receive an input of the user regarding selection of at least one indicator from at least the first set of pointers and the second set of pointers; and
the controller configured to render the at least one type of map and the navigational path corresponding to the user selected indicator within an inner area of the dial of the watch.

12. The system as claimed in claim 11, wherein
the controller is further configured to present pointing directions of an hour hand, a minute hand and a second hand of the watch as representatives of a first indicator, a second indicator and a third indicator selected from the first set of pointers;
a third interface is configured to receive an input from the user to select at least one of the first indicator, the second indicator and the third indicator; and
the controller is configured to control movement of the hour hand, the minute hand and the second hand to map the pointing directions of the user selected indicator and the respective navigational path on the at least one type of map.

13. The system as claimed in claim 12, wherein:
the first indicator indicates a shortest path between the current station and the destination station; the second indicator indicates a fastest path between the current station and the destination station; and the third indicator indicates a safest path between the current station and the destination station.

14. The system as claimed in claim 13, further comprising:
a first crown and a second crown, wherein actuation of the first crown enables the user to select a first mode of operation and actuation of the second crown enables the user to select a second mode of operation, wherein the first mode of operation renders time on the dial and the second mode of operation renders navigational path on the dial.

15. The system as claimed in claim 11, further comprising:
embossed patterns indicating the second set of pointers on the outer periphery of the dial; and
an actuator configured to actuate at least one motor to control rotation movement of the outer periphery of the dial in accordance with movement of the user while the user passes through the rendered navigational direction path.
